(19) United States
(12) Patent Application Publication
(10) Pub. No.: US 2011/0274274 A1
(43) Pub. Date: Nov. 10, 2011

(54) METHOD AND STREAM PROCESSING APPARATUS CAPABLE OF DISTINGUISHING BETWEEN DATA STREAMS INCLUDED IN INTERLACED STREAM BY REFERRING TO AUXILIARY INFORMATION

(76) Inventors: Keng-Jui Hsu, Taipei City (TW); Kan-Li Huang, Taipei City (TW); Yueh-Lun Lee, Taichung City (TW)

(21) Appl. No.: 13/004,892

(22) Filed: Jan. 12, 2011

Related U.S. Application Data
(60) Provisional application No. 61/332,862, filed on May 10, 2010.

(51) Int. Cl. H04N 7/167

(52) U.S. Cl. 380/212

(57) ABSTRACT

A method for processing an interlaced stream includes: receiving the interlaced stream and auxiliary information that are transmitted, respectively, wherein the interlaced stream has a plurality of data streams interlaced therein, and the data streams include at least one encrypted data stream; and generating reference information, utilized for distinguishing between the data streams included in the interlaced stream, by referring to the received auxiliary information.

### CROSS REFERENCE TO RELATED APPLICATIONS

This application claims the benefit of U.S. provisional application No. 61/332,862, filed on May 10, 2010 and incorporated herein by reference.

### BACKGROUND

The disclosed embodiments of the present invention relate to processing an interlaced stream having a plurality of data streams interlaced therein, and more particularly, to a method and stream processing apparatus capable of distinguishing data streams included in an interlaced stream by referring to auxiliary information (e.g., clip information).

Three-dimensional (3D) video presentation technology is developed to improve the viewing entertainment of the end-users. Regarding the 3D video content, it is commonly generated by using different cameras to thereby capture pictures of different views. The captured pictures of different views are then encoded to generate a plurality of bitstreams respectively corresponding to different views. For example, a main transport stream is used to carry left-view (left-eye) pictures, and a dependent transport stream is used to carry right-view (right-eye) pictures. The main transport stream and the dependent transport stream may be stored as individual non-interlaced streams (e.g., two files each having the m2ts format) or a single interlaced stream (e.g., one file having the SSIF format).

In a case where the main transport stream is normally recorded in one m2ts file and the dependent transport stream is normally recorded in another m2ts file, a conventional transport stream demultiplexer simply outputs a main video elementary stream for left-view playback according to the main transport stream and outputs a dependent video elementary stream for right-view playback according to the dependent transport stream. In another case where the main transport stream and the dependent transport stream are normally recorded in one SSIF file (i.e., an interlaced stream mixed by the main transport stream and the dependent transport stream is stored in the SSIF file), a conventional transport stream demultiplexer derives packet identifiers (PIDs) from the interlaced stream, and distinguishes between the main transport stream and the dependent transport stream in the interlaced stream according to the PIDs. In this way, the conventional transport stream demultiplexer outputs a main video elementary stream for left-view playback according to the identified main transport stream, and outputs a dependent video elementary stream for right-view playback according to the identified dependent transport stream.

As the 3D video content includes a main transport stream for left-view playback and a dependent transport stream for right-view playback, the storage requirement of the 3D video content is much higher than that of the two-dimensional (2D) video content. The Blu-ray disc (BD) is an optical storage medium designed to supersede the standard digital versatile disc (DVD). The BD disc may be a good choice to store the 3D video content due to its high storage capacity. However, using the BD disc for storing the 3D video content may encounter the issues of avoiding unauthorized copies of the stored 3D video content and/or the playback of the stored 3D video content using an unauthorized device. A BD Plus (BD+) technology is therefore developed to provide a cryptographic solution to protect the content stored on a BD disc. Taking the 3D video content stored on a BD disc for example, a digital rights management system employing the BD+ solution protects the main transport stream by encryption, and applies no encryption to the dependent transport stream. Consider a case where the main transport stream (which is an encrypted transport stream generated by the BD+ encryption) and the dependent transport stream are recorded in one SSIF file (i.e., an interlaced stream mixed by the main transport stream and the dependent transport stream is stored in the SSIF file), the conventional transport stream demultiplexer is unable to refer to PIDs derived from the interlaced transport stream for distinguishing between the main transport stream and the dependent transport stream in the interlaced stream since the main transport stream is an encrypted transport stream which is not decrypted yet. Thus, the conventional transport stream demultiplex design scheme is not applicable to dealing with the 3D video content protected using the BD+ technology.

There is a need for an innovative transport stream demultiplexer design capable of distinguishing between an encrypted transport stream (e.g., the main transport stream for left-view playback) and a non-encrypted transport stream (e.g., the dependent transport stream for right-view playback) and then processing the encrypted transport stream and the non-encrypted transport stream to accordingly generate respective video elementary streams.

### SUMMARY

In accordance with exemplary embodiments of the present invention, a method and stream processing apparatus capable of distinguishing data streams included in an interlaced stream by referring to auxiliary information (e.g., clip information) are proposed to solve the above-mentioned problem.

According to a first aspect of the present invention, an exemplary method for processing an interlaced stream is disclosed. The exemplary method includes the following steps: receiving the interlaced stream and auxiliary information that are transmitted, respectively, wherein the interlaced stream has a plurality of data streams interlaced therein, and the data streams include at least one encrypted data stream; and generating reference information, utilized for distinguishing between the data streams, by referring to the received auxiliary information.

According to a second aspect of the present invention, an exemplary stream processing apparatus for processing an interlaced stream is disclosed. The exemplary stream processing apparatus includes a receiving circuit and an identifying circuit. The receiving circuit is arranged to receive the interlaced stream and auxiliary information that are transmitted, respectively. The interlaced stream has a plurality of data streams interlaced therein, and the data streams include at least one encrypted data stream. The identifying circuit is coupled to the receiving circuit, and implemented for generating reference information, used for distinguishing between the data streams, by referring to the received auxiliary information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a stream processing apparatus for processing an interlaced stream according to a first exemplary embodiment of the present invention.

FIG. 2 is a diagram illustrating an exemplary stream format of an interlaced stream.

FIG. 3 is a diagram illustrating the clip information of one data stream which is a main transport stream.

FIG. 4 is a diagram illustrating the clip information of another data stream which is a dependent transport stream.

FIG. 5 is a flowchart illustrating operations of an identifying circuit and an extracting unit shown in FIG. 1.

FIG. 6 is a stream processing apparatus for processing an interlaced stream according to a second exemplary embodiment of the present invention.

FIG. 7 is a flowchart illustrating operations of an identifying circuit and a processing circuit shown in FIG. 6.

FIG. 8 is a stream processing apparatus for processing an interlaced stream according to a third exemplary embodiment of the present invention.

FIG. 9 is a flowchart illustrating operations of an identifying circuit and a processing circuit shown in FIG. 8.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The main conception of the present invention is to use any existing auxiliary information available for directly/indirectly providing needed location information of data packets included in an interlaced stream having at least one encrypted data stream included therein. By way of example, but not limitation, the clip information specified in a Blu-ray (BD) specification may be referenced to determine which packets in an interlaced stream belong to the main transport stream (i.e., an encrypted data stream) and which packets in the interlaced stream belong to the dependent transport stream (i.e., a non-encrypted data stream or an encrypted data stream). Further description of the present invention is detailed as follows.

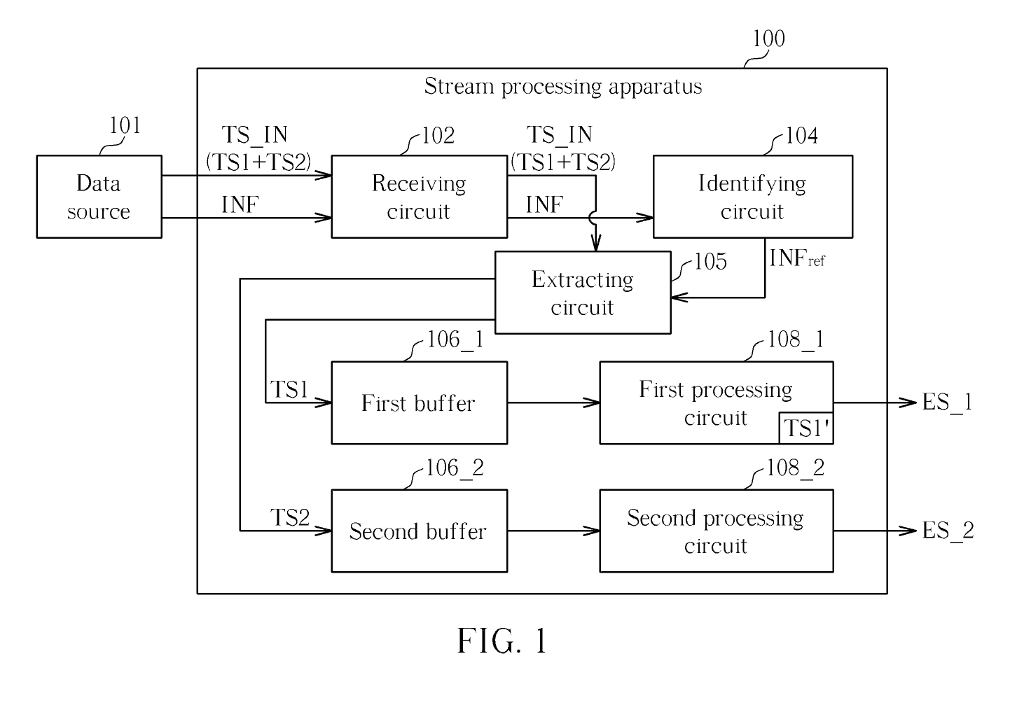

FIG. 1 is a block diagram illustrating a stream processing apparatus for processing an interlaced stream according to a first exemplary embodiment of the present invention. The exemplary apparatus 100 includes, but is not limited to, a receiving circuit 102, an identifying circuit 104, an extracting circuit 105, a first buffer 106_1, a second buffer 106_2, a first processing circuit 108_1, and a second processing circuit 108_2. In this exemplary embodiment, the receiving circuit 102 is arranged to receive an interlaced stream TS_IN and auxiliary information INF. It should be noted that the interlaced stream TS_IN and the auxiliary information INF are transmitted, respectively. That is, the auxiliary information INF is not embedded in the interlaced stream TS_IN, and is provided separately. Thus, the data transmitted by the auxiliary information INF can be obtained even though the interlaced stream TS_IN has at least one encrypted data stream included therein.

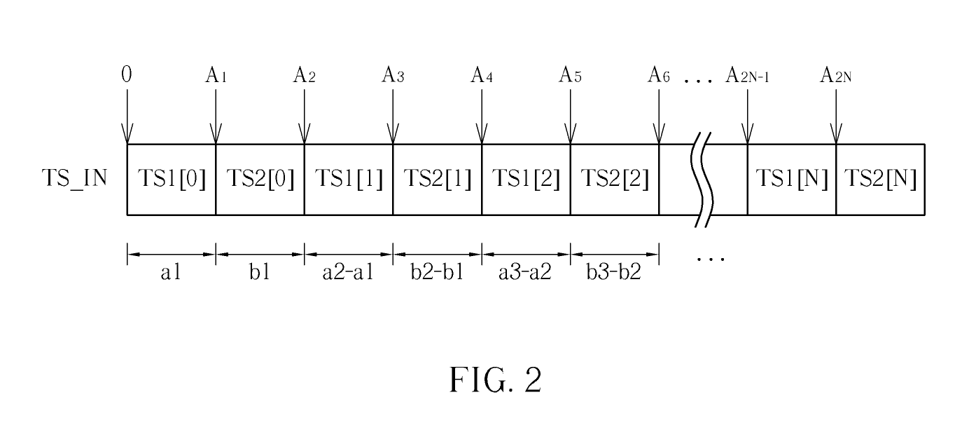

In this exemplary embodiment, the interlaced stream TS_IN has a plurality of data streams, such as a first data stream TS1 and a second data stream TS2, interlaced therein. Please refer to FIG. 2, which is a diagram illustrating an exemplary stream format of the interlaced stream TS_IN. The first data stream TS1 includes a plurality of data packets TS1[0]-TS1[N]; similarly, the second data stream TS2 includes a plurality of data packets TS2[0]-TS2[N]. The successive data packets in the interlaced stream TS_IN have actual start points 0-A_{2N}, respectively. As can be seen from FIG. 2, one data packet of the first data stream TS1 is immediately followed by one data packet of the second data stream TS2. However, this is for illustrative purposes only, and is not meant to be taken as a limitation of the present invention. That is, in an alternative design of the present invention, the interlaced stream TS_IN may have the first data stream TS1 and the second data stream TS2 interlaced in a different manner.

Regarding the interlaced stream TS_IN in this exemplary embodiment, the first and second data streams TS1 and TS2 include at least one encrypted data stream. For example, the first data stream TS1 may be an encrypted data stream. Therefore, the data packets TS1[0]-TS1[N] are encrypted data packets generated by a specific encryption/scrambling scheme. For example, the first and second data streams TS1 and TS2 in this exemplary embodiment are used for 3D playback, where at least a main transport stream (e.g., the first data stream TS1) is an encrypted data stream encrypted using a specific encryption/scrambling scheme, such as the aforementioned BD+ encryption.

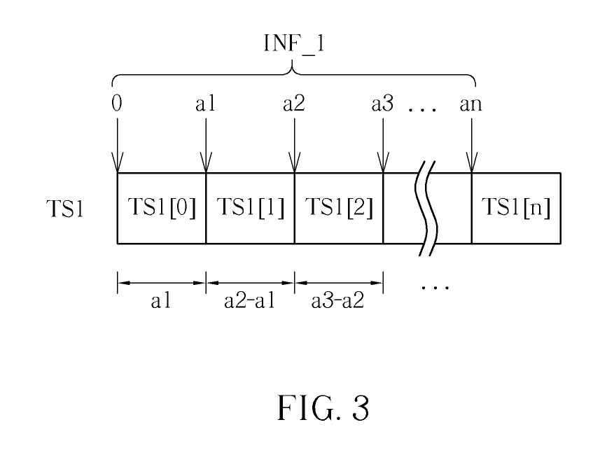

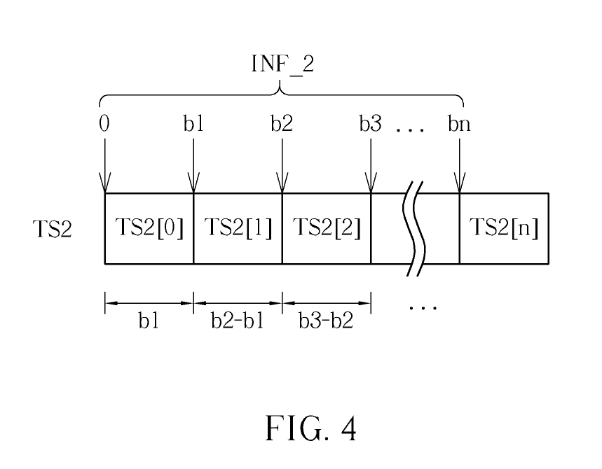

The auxiliary information INF may provide information about the location of each data packet included in the interlaced stream TS_IN. By way of example, but not limitation, the auxiliary information INF may include start point information of each data packet included in the first and second data streams TS1 and TS2. As shown in FIG. 1, the receiving circuit 102 may receive the interlaced stream TS_IN and the auxiliary information INF from the same data source 101, respectively. For example, the data source is a Blu-ray disc (BD). Therefore, the auxiliary information INF may be clip information specified in the BD specification. Please refer to FIG. 3 and FIG. 4. FIG. 3 is a diagram illustrating the clip information INF_1 of the first data stream TS1 which may act as the main transport stream, and FIG. 4 is a diagram illustrating the clip information INF_2 of the second data stream TS2 which may act as the dependent transport stream. As shown in FIG. 3 and FIG. 4, the clip information INF_1 includes start points 0, a1, a2, . . . , an of successive data packets TS1[0], TS1[1], TS1[2], . . . , TS1[N] included in the first data stream TS1, and the clip information INF_2 includes start points 0, b1, b2, . . . , bn of successive data packets TS2[0], TS2[1], TS2[2], . . . , TS2[N] included in the second data stream TS2. As the first and second data streams TS1 and TS2 are interlaced in the interlaced stream TS_IN, the original clip information INF_1 and INF_2 (i.e., the start point information) may not be directly used to determine the location of each data packet in the interlaced stream TS_IN. However, the original clip information INF_1 and INF_2 still provide useful information which can be referenced by the identifying circuit 104 to identify the encrypted data stream(s) from the interlaced stream TS_IN.

The identifying circuit 104 is coupled to the receiving circuit 102, and implemented for generating reference information INF_{ref}, utilized for distinguishing between the data streams included the interlaced stream TS_IN, by referring to the received auxiliary information INF. For example, the reference information INF_{ref} may be used for identifying at least one encrypted data stream (e.g., the first data stream TS1) from the received interlaced stream TS_IN. In this exemplary embodiment, the identifying circuit 104 may calculate a plurality of offsets (e.g., a1, a2-a1, and a3-a2 as shown in FIG. 3) according to the start position information given by the clip information INF_1, and also calculate a plurality of offsets (e.g., b1, b2-b1, and b3-b2 as shown in FIG. 4) according to the start position information given by the clip information INF_2. Next, the identifying circuit 104 provides the calculated offsets to the extracting circuit 105 such that the extracting circuit 105 can correctly distinguish between data packets belonging to the first data stream TS1 and data packets belonging to the second data stream TS2. More specifically, as the interlaced stream TS_IN is started with the first data packet TS1[0] of the first data stream TS1 (e.g., the interlaced stream of the 3D video content is generally started with the first packet of the main transport stream), the identifying circuit 104 sequentially outputs the calculated offsets a1, b1, a2-a1, b2-b1, a3-a2, b3-b2, etc. as shown in FIG. 2, and then the extracting circuit 105 identifies the encrypted data stream (e.g., the first data stream TS1) from the received interlaced stream TS_IN according to the calculated offsets (i.e., the reference information INF_{ref}). Therefore, by properly referring to the calculated offsets INF_{ref} derived from the clip information INF_1 and INF_2, the actual start points 0-A_{2N} of the data packets in the interlaced stream TS_IN can be easily identified. In this way, each data packet in the interlaced stream TS_IN can be correctly categorized as a data packet belonging to the first data stream TS1 or a data packet belonging to the second data stream TS2.

The identifying circuit 104 and the extracting circuit 105 may act as a transport stream packet identifier. In this exemplary embodiment, the extracting circuit 105 is therefore implemented to gather and store data packets of the identified data stream TS1 (e.g., data packets of an identified main transport stream which is an encrypted data stream in this exemplary embodiment) into the first buffer 106_1, and also gather and store data packets of the second data stream TS2 (e.g., data packets of an identified dependent transport stream which is a non-encrypted data stream in this exemplary embodiment) into the second buffer 106_2.

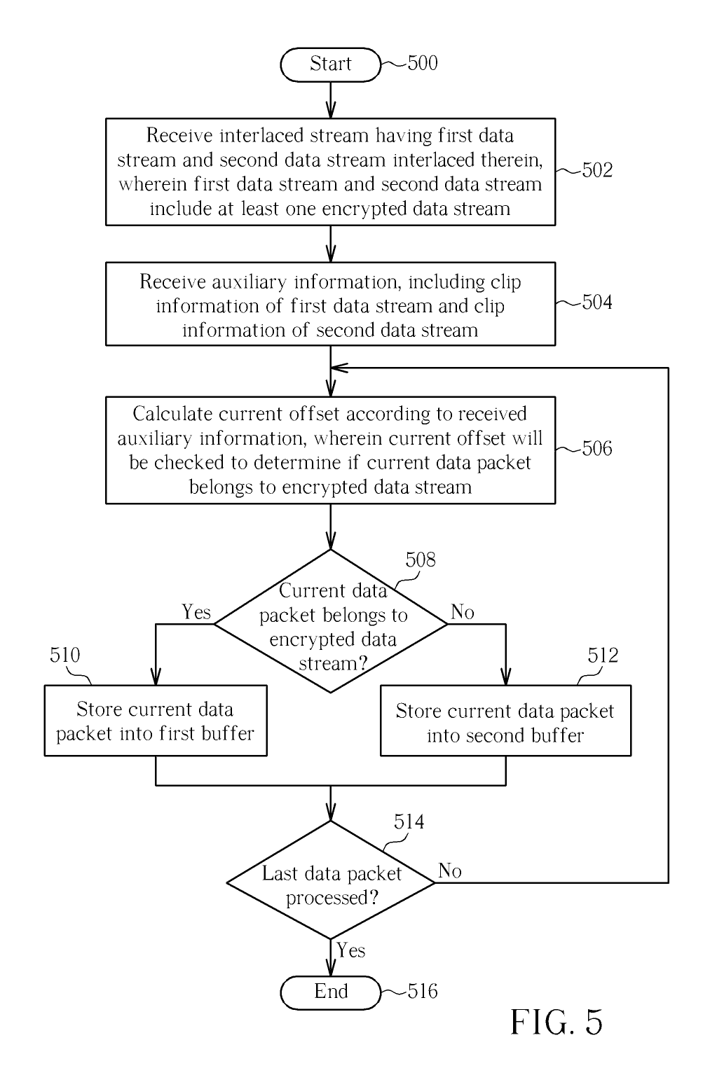

Please refer to FIG. 5, which is a flowchart illustrating operations of the identifying circuit 104 and the extracting unit 105 shown in FIG. 1. Provided that the result is substantially the same, the steps in FIG. 5 are not required to be executed in the exact order shown in FIG. 5. The flow may be briefly summarized as follows.

Step 500: Start.

Step 502: Receive an interlaced stream TS_IN having first and second data streams TS1 and TS2 interlaced therein, wherein the first and second data streams TS1 and TS2 include at least one encrypted data stream. For example, the data stream TS1 is an encrypted data stream.

Step 504: Receive auxiliary information INF, including clip information INF_1 of the first data stream TS1 and clip information INF_2 of the second data stream TS2.

Step 506: Calculate a current offset according to the received clip information INF_1/INF_2.

Step 508: Check if a current data packet included in the received interlaced stream TS_IN is a data packet belonging to the first data stream TS1 (e.g., a data packet of an encrypted data stream) by referring to the calculated current offset. If yes, go to step 510; otherwise, go to step 512.

Step 510: Store the current data packet into a first buffer 106_1.

Step 512: Store the current data packet into a second buffer 106_2.

Step 514: Check if the last data packet in the interlaced stream TS_IN has been processed. If yes, go to step 516; otherwise, go to step 506 to deal with identification of the next data packet.

Step 516: End.

In step 514, the end of the interlaced stream TS_IN may be identified by comparing an offset accumulation result with a length of the interlaced stream TS_IN. Taking the interlaced stream TS_IN in FIG. 2 for example, the length of the interlaced stream TS_IN may be obtained from a header (not shown). Step 514 may accumulate each offset calculated in step 506 and accordingly obtain the offset accumulation result. When the current offset accumulation result is found equal to the length of the interlaced stream TS_IN, it is determined that the last data packet (i.e., the data packet TS2[N]) has been processed. However, this is for illustrative purposes only. Using other determination scheme to judge whether the last data packet has been processed is feasible.

As a person skilled in the art can readily understand the operation of each step in FIG. 5 after reading above paragraphs directed to the identifying circuit 104 shown in FIG. 1, further description is omitted here for brevity.

The first processing circuit 108_1 is coupled to the first buffer 106_1 and may be equipped with the decryption capability for generating a decrypted output stream TS1′ corresponding to the encrypted data stream (i.e., the first data stream TS1) by processing the data packets TS1[0]-TS1[N] stored in the first buffer 106_1. Moreover, the first processing circuit 108_1 may also have the transport stream demultiplexing capability for generating a main video elementary stream ES1 according to the decrypted output stream TS1′. As the second data stream TS2 is a non-encrypted data stream in this exemplary embodiment, the second processing circuit 108_2 may serve as a transport stream demultiplexer and therefore generate a dependent video elementary stream ES_2 by directly applying the transport stream demultiplexing operation upon the data packets TS2[0]-TS2[N] stored in the second buffer 106_2.

As shown in FIG. 1, the stream processing apparatus 100 requires a plurality of buffers, such as the first buffer 106_1 and the second buffer 106_2, for buffering data packets of different data streams, respectively. If one of the first buffer 106_1 and the second buffer 106_2 is implemented using a packet buffer originally used in a conventional stream processing apparatus, the exemplary implementation of the stream processing apparatus 100, compared to that of the conventional stream processing apparatus, requires an additional packet buffer employed therein. To reduce the hardware resource usage and improve the overall stream processing performance, the present invention proposes alternative designs of the stream processing apparatus.

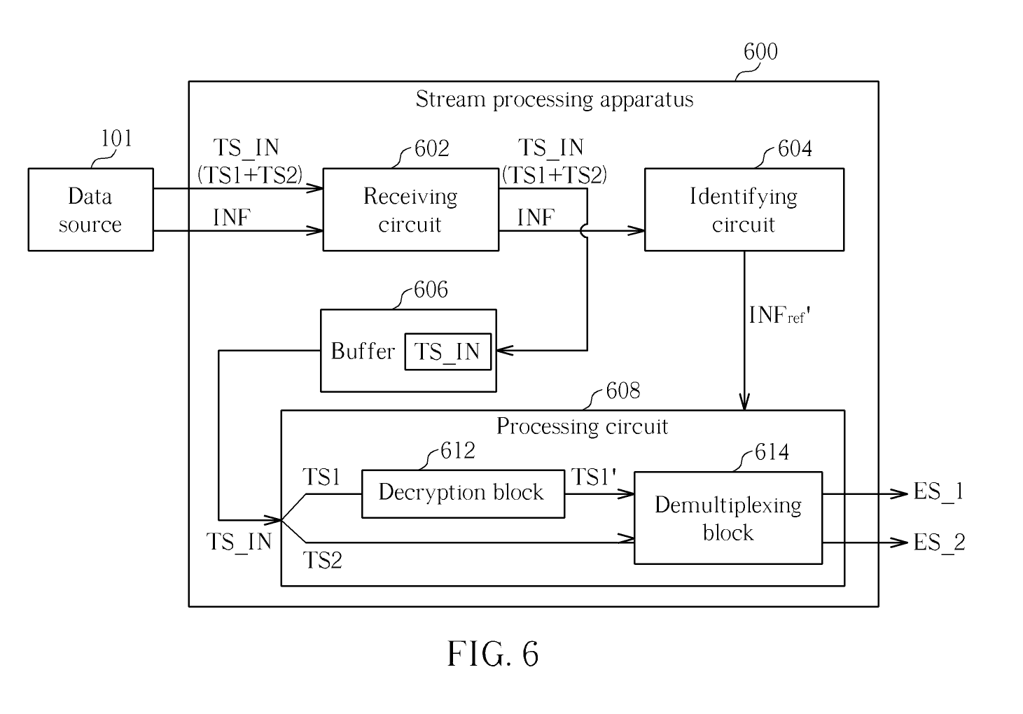

Please refer to FIG. 6, which is a stream processing apparatus for processing an interlaced stream according to a second exemplary embodiment of the present invention. The exemplary stream processing apparatus 600 includes, but is not limited to, a receiving circuit 602, an identifying circuit 604, a buffer 606, and a processing circuit 608. In this exemplary embodiment, the receiving circuit 602 is arranged to receive an interlaced stream TS_IN and auxiliary information INF from the same data source 101 such as a BD disc. As mentioned above, the interlaced stream TS_IN and the auxiliary information INF are transmitted, respectively. The interlaced stream TS_IN has a plurality of data streams, such as the first data stream TS1 and the second data stream TS2, interlaced therein, wherein at least one of the data streams (e.g., the first data stream TS1) is an encrypted data stream encrypted using a specific encryption/scrambling scheme (e.g., a BD+ encryption). Additionally, the auxiliary information INF may include clip information INF_1 of the first data stream TS1 and clip information INF_2 of the second data stream TS2. As details of the interlaced stream TS_IN and the auxiliary information INF have been discussed above, further description is omitted here for brevity.

In this exemplary embodiment, the identifying circuit 604 is arranged to provide the processing circuit 608 with reference information INF_{ref}′ such that the processing circuit 608 can distinguish between different data streams interlaced in the interlaced stream TS_NI. The identifying circuit 604 may act as a transport stream packet marker used to generate the reference information INF_{ref}′ including a plurality of indication marks, where the generated indication marks may be stored in a look-up table to be referred to by the processing circuit 608. More specifically, regarding each data packet included in the interlaced stream TS_IN, the identifying circuit 604 generates an indication mark indicative of a data packet in the interlaced stream TS_IN by referring to the received auxiliary information INF. For example, by properly accumulating the calculated offsets derived from the clip information INF_1 and INF_2, the actual start points 0-A_{2N} of the data packets in the interlaced stream TS_IN shown in FIG. 2 can be easily identified. In this way, each data packet in the interlaced stream TS_IN can be correctly categorized as a data packet belonging to the first data stream TS1 or a data packet belonging to the second data stream TS2.

By way of example, but not limitation, the aforementioned indication mark may be a flag used to indicate the beginning of a data packet belonging to a data stream TS1/TS2. Alternatively, the aforementioned indication mark may indicate an address range to which a data packet belonging to a data stream TS1/TS2 corresponds. Thus, with the help of the reference information INF_{ref}′ (e.g., indication marks designated to the data packets included in the interlaced stream TS_IN), the processing circuit 608 can correctly distinguish between data packets of the first data stream TS1 and data packets of the second data stream TS2. To put it another way, the processing circuit 608 is capable of identifying data packets of an encrypted data stream (e.g., the first data stream TS1) from the interlaced stream TS_IN by referring to the reference information INF_{ref}′.

As shown in FIG. 6, the exemplary stream processing apparatus 600 has one buffer 606 employed for storing the interlaced stream TS_IN received by the receiving circuit 602. It should be noted that the data packets in the buffer 606 are stored in an interlaced format. That is, the data packets TS1[0], TS2[0], TS1[1], TS2[1], . . . , TS1[N], and TS2[N] of the interlaced stream TS_IN are sequentially stored into the buffer 606. The processing circuit 608 is coupled to the buffer 606 and the identifying circuit 604, and implemented for generating at least one decrypted output stream corresponding to the at least one encrypted data stream by processing the interlaced stream TS_IN stored in the buffer 606 according to the reference information INF_{ref}′. In this exemplary embodiment, the processing circuit 608 may include a decryption block 612 and a demultiplexing block 614. When the processing circuit 608 identifies that a current data packet read from the buffer 606 belongs to the first data stream TS1 which is an encrypted data stream (e.g., a main transport stream encrypted using the BD+ encryption), the current data packet will be fed into the decryption block 612. Next, the decryption block 612 generates a decrypted data packet accordingly. On the other hand, when the processing circuit 608 identifies that a current data packet read from the buffer 606 belongs to the second data stream TS2 which is a non-encrypted data stream (e.g., a dependent transport stream with no BD+ encryption applied thereto), the current data packet will be bypassed to the demultiplexing block 614 without entering the decryption block 612. Though the interlaced data packets TS1[0], TS2[0], . . . , TS1[N], and TS2[N] stored in the buffer 606 are sequentially transmitted to the processing circuit 608, the processing circuit 608 is capable of distinguishing between data packets TS1[0]-TS1[N] of the first data stream TS1 and data packets TS2[0]-TS2[N] of the second data stream TS2 according to the reference information INF_{ref}′ (e.g., indication marks) given by the identifying circuit 604. Therefore, the processing circuit 608 is capable of generating a decrypted output stream TS1′ to the demultiplexing block 614 corresponding to the encrypted data stream (i.e., the first data stream TS1) by processing the data packets TS1[0]-TS1[N] stored in the buffer 606, and transmitting the non-encrypted data stream (i.e., the second data stream TS2) to the demultiplexing block 614 without any decryption applied thereto. The demultiplexing block 614 performs a transport stream demultiplexing operation upon the decrypted output stream TS1′ and accordingly generates a main video elementary stream ES_1, and performs a transport stream demultiplexing operation upon the second data stream TS2 and accordingly generates a dependent video elementary stream ES_2.

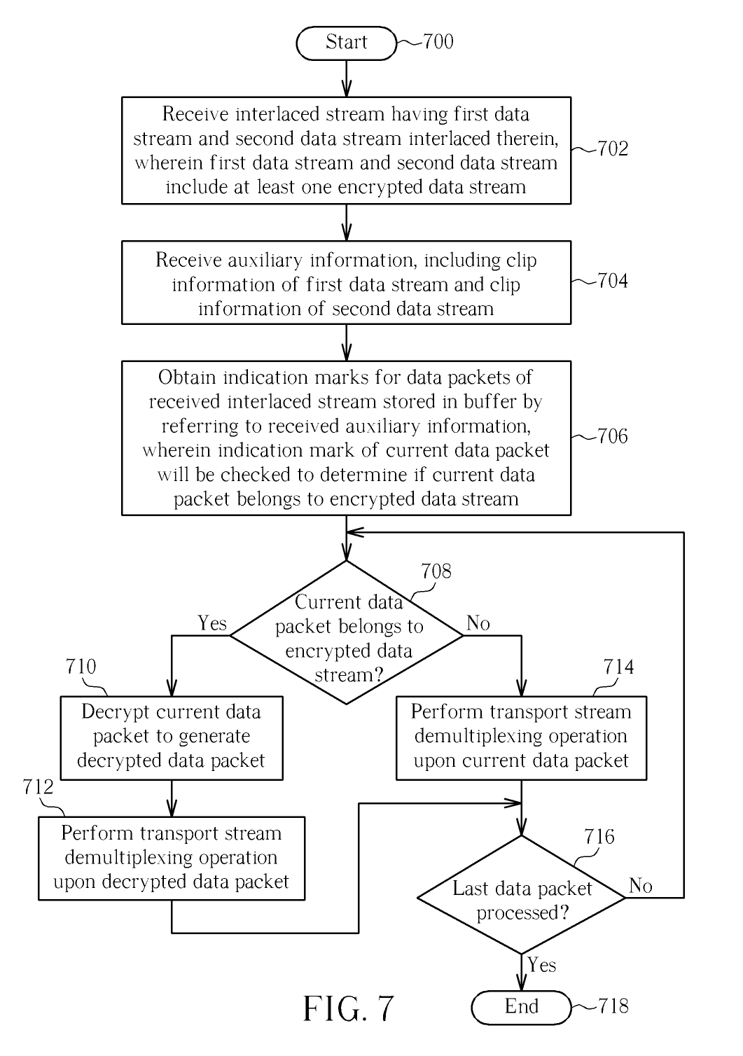

Please refer to FIG. 7, which is a flowchart illustrating operations of the identifying circuit 604 and the processing circuit 608 shown in FIG. 6. Provided that the result is substantially the same, the steps in FIG. 7 are not required to be executed in the exact order shown in FIG. 7. The flow may be briefly summarized as follows.

Step 700: Start.

Step 702: Receive an interlaced stream TS_IN having first and second data streams TS1 and TS2 interlaced therein, wherein the first and second data streams TS1 and TS2 include at least one encrypted data stream (e.g., the first data stream TS1).

Step 704: Receive auxiliary information INF, including clip information INF_1 of the first data stream TS1 and clip information INF_2 of the second data stream TS2.

Step 706: Obtain indication marks for data packets of the interlaced stream TS_IN stored in a buffer 606 by referring to the received clip information INF_1 and INF_2.

Step 708: Check if a current data packet included in the interlaced stream TS_IN read from the buffer 606 is a data packet belonging to the first data stream TS1 (e.g., a data packet of an encrypted data stream) by referring to a corresponding indication mark. If yes, go to step 710; otherwise, go to step 714.

Step 710: Decrypt the current data packet to generate a decrypted data packet.

Step 712: Perform a transport stream demultiplexing operation upon the decrypted data packet. Go to step 716.

Step 714: Perform a transport stream demultiplexing operation upon the current data packet.

Step 716: Check if the last data packet in the interlaced stream TS_IN has been processed. If yes, go to step 718; otherwise, go to step 708 to deal with the next data packet.

Step 718: End.

Similarly, step 716 may identify the end of the interlaced stream TS_IN by comparing an offset accumulation result of the calculated offsets with a length of the interlaced stream TS_IN derived from a header. However, this is for illustrative purposes only. Using other determination scheme to judge whether the last data packet has been processed is feasible.

As a person skilled in the art can readily understand the operation of each step in FIG. 7 after reading above paragraphs directed to the identifying circuit 604 and the processing circuit 608 shown in FIG. 6, further description is omitted here for brevity.

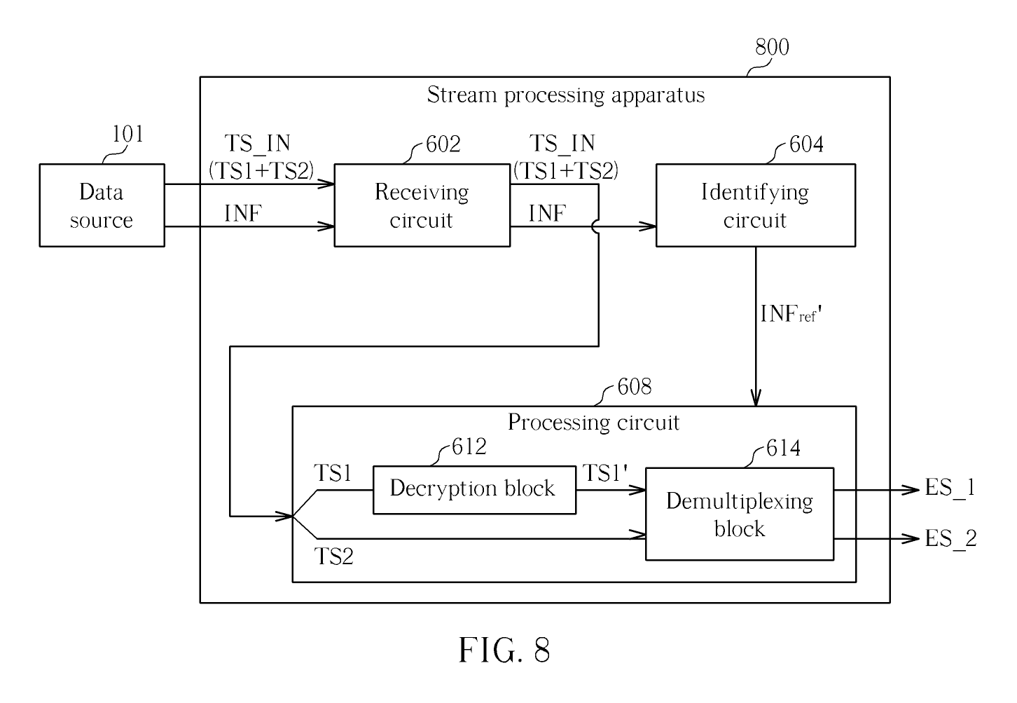

In above exemplary embodiment shown in FIG. 6, the buffer 606 is used to temporarily store data packets of the incoming interlaced stream TS_IN. In addition, with the buffer 606 implemented for buffering the data packets, the processing circuit 608 does not start processing a data packet stored in the buffer 606 until a corresponding indication mark of the stored data packet is received for identifying whether the stored data packet is a data packet belonging to the first data stream TS1. However, with a proper design of the identifying circuit 604 and the processing circuit 608, the buffer 606 may be omitted. For example, in a case where an indication mark of a data packet to be processed by the processing circuit is guaranteed to be generated and provided to the processing circuit in time, the processing circuit is allowed to start processing the data packet upon receiving the data packet. FIG. 8 is a stream processing apparatus for processing an interlaced stream according to a third exemplary embodiment of the present invention. The structure of the exemplary stream processing apparatus 800 is similar to that of the exemplary stream processing apparatus 600 shown in FIG. 6, and the major difference therebetween is that the processing circuit 608 in FIG. 8 directly receives the interlaced stream TS_IN from the receiving circuit 602. In other words, regarding the stream processing apparatus 800, there is no packet buffer disposed between the receiving circuit 602 and the processing circuit 608. Therefore, upon receiving a specific data packet of at least one encrypted data stream (e.g., the first data stream TS1), the processing circuit 608 in FIG. 8 starts a decryption operation upon the specific data packet identified by a corresponding indication mark generated from the identifying circuit 604 in FIG. 8.

It should be noted that any modification made to the exemplary stream processing apparatus 800 shown in FIG. 8 is feasible as long as the spirit of the present invention is obeyed. For example, in an alternative design, the descryption block 612 may be integrated with other circuit such as the identifying circuit 604. In this way, a modified circuit block, having the identifying circuit 604 and the descryption block 612 integrated therein, directly generates the descrypted output stream TS1′ and the non-encrypted data stream TS2 to the demultiplexing block 614. The same objective of feeding identified data streams (e.g., TS1′ and TS2) into the demultiplexing block 614 is achieved though packet identification and packet descryption are performed in one circuit block. This also falls within the scope of the present invention.

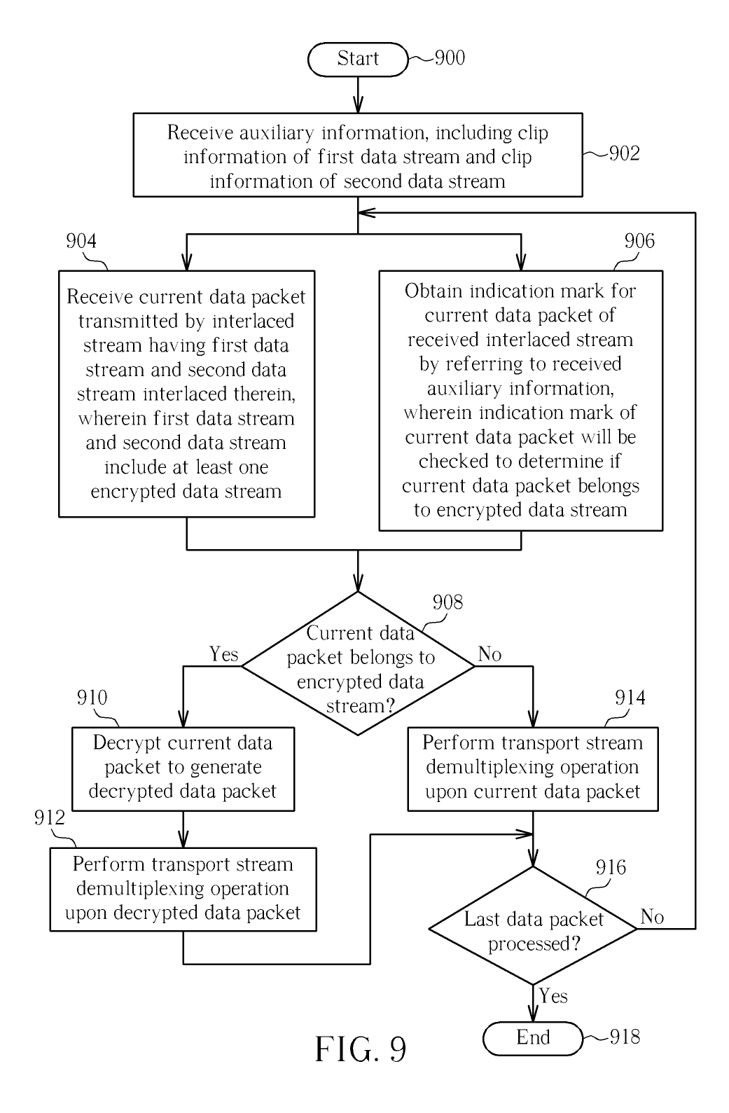

Please refer to FIG. 9, which is a flowchart illustrating operations of the identifying circuit 604 and the processing circuit 608 shown in FIG. 8. Provided that the result is substantially the same, the steps in FIG. 9 are not required to be executed in the exact order shown in FIG. 9. The flow may be briefly summarized as follows.

Step 900: Start.

Step 902: Receive auxiliary information INF, including clip information INF_1 of the first data stream TS1 and clip information INF_2 of the second data stream TS2. Proceed to steps 902 and step 904 in a parallel processing manner.

Step 904: Receive a current data packet transmitted by an interlaced stream TS_IN having the first and second data streams TS1 and TS2 interlaced therein, wherein the first and second data streams TS1 and TS2 include at least one encrypted data stream (e.g., the first data stream TS1). Go to step 908.

Step 906: Obtain an indication mark for the current data packet of the received interlaced stream TS_IN by referring to the received clip information INF_1 and INF_2.

Step 908: Check if a current data packet included in the interlaced stream TS_IN is a data packet belonging to the first data stream TS1 (e.g., a data packet of an encrypted data stream) by referring to the current indication mark. If yes, go to step 910; otherwise, go to step 914.

Step 910: Decrypt the current data packet to generate a decrypted data packet.

Step 912: Perform a transport stream demultiplexing operation upon the decrypted data packet. Go to step 916.

Step 914: Perform a transport stream demultiplexing operation upon the current data packet.

Step 916: Check if the last data packet in the interlaced stream TS_IN has been processed. If yes, go to step 918; otherwise, proceed to steps 904 and 906 in a parallel processing manner for dealing with the next data packet.

Step 918: End.

Similarly, step 916 may identify the end of the interlaced stream TS_IN by comparing an offset accumulation result of the calculated offsets with a length of the interlaced stream TS_IN derived from a header. However, this is for illustrative purposes only. Using other determination scheme to judge whether the last data packet has been processed is feasible.

As a person skilled in the art can readily understand the operation of each step in FIG. 9 after reading above paragraphs, further description is omitted here for brevity.

In above exemplary embodiments, the incoming interlaced stream TS_IN to be processed by the stream processing apparatus 100/600/800 includes one encrypted data stream (e.g., a main transport stream for left-view playback) and one non-encrypted data stream (e.g., a dependent transport stream for right-view playback). However, this is not meant to be a limitation of the present invention. Consider a case where the incoming interlaced stream TS_IN has a plurality of encrypted data streams. The above-mentioned packet identifying scheme may be employed to deal with such an interlaced stream TS_IN by referring to auxiliary information (e.g., clip information). In short, the above-mentioned packet identifying scheme is capable of distinguishing data packets of different data streams interlaced in an interlaced stream by referring to the auxiliary information which is provided separately.

Those skilled in the art will readily observe that numerous modifications and alterations of the device and method may be made while retaining the teachings of the invention.

What is claimed is:

1. A method for processing an interlaced stream, comprising:
receiving the interlaced stream and auxiliary information that are transmitted, respectively, wherein the interlaced stream has a plurality of data streams interlaced therein, and the data streams include at least one encrypted data stream; and
generating reference information utilized for distinguishing between the data streams in the interlaced stream, by referring to the received auxiliary information.

2. The method of claim 1, wherein the data streams include a main transport stream and a dependent transport stream for three-dimensional (3D) playback, and the main transport stream is included in the at least one encrypted data stream.

3. The method of claim 1, wherein the step of receiving the interlaced stream and the auxiliary information comprises:
receiving the interlaced stream and the auxiliary information from a same data source, respectively.

4. The method of claim 3, wherein the same data source is a Blu-ray disc (BD).

5. The method of claim 1, wherein the auxiliary information includes start point information of each data packet included in the data streams.

6. The method of claim 5, wherein the auxiliary information is clip information specified in a Blu-ray disc (BD) specification.

7. The method of claim 1, further comprising:
gathering and storing data packets of the identified at least one encrypted data stream into a buffer according to the reference information; and
generating at least one decrypted output stream corresponding to the at least one encrypted data stream by processing the data packets stored in the buffer.

8. The method of claim 1, wherein the step of generating the reference information comprises:
regarding each data packet included in the at least one encrypted data stream of the interlaced stream, generating an indication mark indicative of the data packet in the at least one encrypted data stream by referring to the received auxiliary information; and
the method further comprises:
storing the received interlaced stream into a buffer; and
generating at least one decrypted output stream corresponding to the at least one encrypted data stream by processing the interlaced stream stored in the buffer according to a plurality of indication marks of the data packets.

9. The method of claim 1, wherein the step of generating the reference information comprises:
regarding each data packet included in the at least one encrypted data stream of the interlaced stream, generating an indication mark indicative of the data packet in the at least one encrypted data stream by referring to the received auxiliary information; and
the method further comprises:
upon receiving a specific data packet of the at least one encrypted data stream, starting a decryption operation upon the specific data packet identified by a corresponding indication mark.

10. A stream processing apparatus for processing an interlaced stream, comprising:
a receiving circuit, arranged to receive the interlaced stream and auxiliary information that are transmitted, respectively, wherein the interlaced stream has a plurality of data streams interlaced therein, and the data streams include at least one encrypted data stream; and
an identifying circuit, coupled to the receiving circuit, for generating reference information, utilized for distinguishing between the data streams in the interlaced stream, by referring to the received auxiliary information.

11. The stream processing apparatus of claim 10, wherein the data streams include a main transport stream and a dependent transport stream for three-dimensional (3D) playback, and the main transport stream is included in the at least one encrypted data stream.

12. The stream processing apparatus of claim 10, wherein the receiving circuit receives the interlaced stream and the auxiliary information from a same data source, respectively.

13. The stream processing apparatus of claim 12, wherein the same data source is a Blu-ray disc (BD).

14. The stream processing apparatus of claim 10, wherein the auxiliary information includes start point information of each data packet included in the data streams.

15. The stream processing apparatus of claim 14, wherein the auxiliary information is clip information specified in a Blu-ray disc (BD) specification.

16. The stream processing apparatus of claim 10, further comprising:
a buffer;
an extracting circuit, coupled to the identifying circuit and the buffer, for gathering and storing data packets of the identified at least one encrypted data stream into the buffer according to the reference information; and
a processing circuit, coupled to the buffer, for generating at least one decrypted output stream corresponding to the at least one encrypted data stream by processing the data packets stored in the buffer.

17. The stream processing apparatus of claim 10, wherein regarding each data packet included in the at least one encrypted data stream of the interlaced stream, the identifying circuit generates an indication mark indicative of the data packet in the at least one encrypted data stream by referring to the received auxiliary information; and the stream processing apparatus further comprises:
a buffer, coupled to the receiving circuit, for storing the interlaced stream; and
a processing circuit, coupled to the buffer and the identifying circuit, for generating at least one decrypted output stream corresponding to the at least one encrypted data stream by processing the interlaced stream stored in the buffer according to a plurality of indication marks of the data packets.

18. The stream processing apparatus of claim 10, wherein regarding each data packet included in the at least one encrypted data stream of the interlaced stream, the identifying circuit generates an indication mark indicative of the data packet in the at least one encrypted data stream by referring to the received auxiliary information; and the stream processing apparatus further comprises:
a processing circuit, coupled to the receiving circuit and the identifying circuit, wherein upon receiving a specific data packet of the at least one encrypted data stream, the processing circuit starts a decryption operation upon the specific data packet identified by a corresponding indication mark generated from the identifying circuit.
